(19) United States
(12) Patent Application Publication
(10) Pub. No.: US 2004/0052905 A1
(43) Pub. Date: Mar. 18, 2004

(54) Animal feed in granular form and process of preparing same

(75) Inventors: Marcelin Pelletier, Saint-Nicolas (CA); Guy Belanger, Saint-Jean-Chrysostome (CA)

Correspondence Address: CROWELL & MORING LLP, INTELLECTUAL PROPERTY GROUP, P.O. BOX 14300, WASHINGTON, DC, 20044-4300, US

(73) Assignee: Aliments Breton Inc., Saint-Bernard (CA)

(21) Appl. No.: 10/245,726

(22) Filed: Sep. 18, 2002

(51) Int. Cl. A23K 1/175

(52) U.S. Cl. 426/74

(57) ABSTRACT

The animal food in granular form is essentially spherical and contains a food material, an inorganic food supplement or both and the granules are of generally uniform size between 3 mm and 25 mm. The granules have a moisture content between 5 and 20%, a PDI higher than 90% and a coefficient of variability lower than 10. The granules are prepared by a tumbling process which may include the use of a binder.

### BACKGROUND OF INVENTION

a) Field of the Invention

The present invention relates to a granular form of feed for animals, particularly livestock. More specifically, the present invention is concerned with a form of feed or supplementary feed that is particularly attractive to animals, in the sense that this feed is easily accepted by the animals.

b) Description of Prior Art

It is well know that in order to produce and maintain healthy animals, such as cattle, they must be fed with nutrients and supplementary additives, such as cereals, minerals, vitamins, medicaments, and the like that are presented to the animals in a form that is likely to be well accepted. It is also well known that when the feed contains too much dust, or is in a form that is more or less heterogenous, it is not normally attracted to the animals. On the other hand, treating a nutrient or supplemented feed for animals to remove excess dust is a cumbersome and expensive process that complicates the preparation of the feed. Nutrients and supplementary additives in powder form are not acceptable for most of the animals, and there is therefore a need to find a replacement that is well accepted by animals and that does not need heat exposure to produce it in final form.

The prior art describes animal feeds in granular form, such as in the following references:

U.S. Pat. Nos.

U.S. Pat. No. 6,306,427

U.S. Pat. No. 6,238,709

U.S. Pat. No. 6,221,424

U.S. Pat. No. 5,997,939

U.S. Pat. No. 5,629,038

U.S. Pat. No. 5,622,710

U.S. Pat. No. 4,349,578

U.S. Pat. No. 4,323,584

Canadian Patent

1,109,318

Except for providing animal feeds for animals of various compositions, none of the above references teach characteristics for the granules that render the feeds particularly attractive to the animals, while enabling the manufacturer to prepare them in a form that is easy to deliver to the buyer. There is therefore a need for animal feeds or supplementary additives that are characterized by being well accepted by the animals and are presented in a form that is easy to handle.

### SUMMARY OF INVENTION

It is an object of the present invention to provide a feed for animals, particularly livestock, that is substantially free from dust, cheap to produce and is well accepted by the animals.

It is another object of the present invention to provide a manufacturing process that lends itself to produce feeds for animals according to ingredients requested by the buyer. and that gives a product with desired characteristics that could not otherwise be obtained.

The above and other object of the present invention may be achieved by providing feed for animals in granular form, wherein the granules are essentially spherical and contain at least one element selected from the group consisting of at least on food material, at least one inorganic food supplement, and mixtures thereof. The granules are of generally uniform size between about 3 mm and 25 mm, they have a moisture content between about 5 and 20%, a Pellet Durability Index (PDI) higher than about 90% and a coefficient of variability lower than 10.

As used in the present specification and in the appended claims, the terms Pellet Durability Index (PDI) and coefficient of variability are defined as follows:

Pellet Durability Index: it is a measure of the durability of pellets. The degradation of the pellet during handling is estimated with a durability tumbling tester. It is the weight of the pellets after tumbling divided by the weight before tumbling, which is then multiplied by 100. A Borregaard Pellet Durability Tester was used for our tests.

Coefficient of variability: the coefficient of variability (C.V.) is provided as an estimate of the precision of the data with respect to the mean. This coefficient is calculated by dividing the standard deviation by the mean which is then multiplied by 100.

The feed according to the invention may additionally comprises a binder, such as molasses. Of course other types of binders may be used as is well known to those skilled in the art.

The feed according to the invention, may comprise a food material only, or be manufactured exclusively of an inorganic food supplement, or may contain both the food material and the inorganic food supplement.

When a food material is used in the feed according to the invention, it preferably consists of at least one cereal, or by-products thereof, such as wheat, corn, oat, rye, canola, barley, or mixtures thereof.

The moisture content is preferably between about 8 and 10%.

In accordance with a preferred embodiment of the invention the food supplement is preferably based on at least one of the following: phosphorus, calcium, magnesium, sodium, chlorine, copper, iron, iodine, manganese, selenium and zinc.

For example, the inorganic food supplement may contain calcium carbonate, magnesium oxide, mono-dicalcium phosphate, sodium chloride while in this case the food material comprises wheat. Another example is a food supplement that contains mono-ammonium phosphate, magnesium oxide and mono-dicalcium phosphate. In this case, the food material also comprises wheat.

In accordance with another preferred embodiment, a feed for animals according to the invention may additionally comprises at least one of vitamins, medicaments, dyes or mixtures thereof and the choice is left entirely to one skilled in the art.

The feed for animals according to the present invention may be prepared as follows.

First, there is provided a powdery composition comprising at least one substance selected from the group consisting of at least one animal food material, at least one inorganic animal food supplement, and mixtures thereof. The powdery substance is then moistened with water, optionally in the presence of a binder, such as molasses, and the water moistened composition is tumbled until obtaining substantially spherical granules of generally uniform size between about 3 mm and 25 mm. The amount of water added to moisten the composition is such that the granules have a moisture content between about 5 and 20%.

### EXAMPLES

The invention is illustrated but is not limited by the following examples.

### Example 1

One metric ton of a granular feed was prepared by the process described above. The ingredients include the following:

| | |
|---|---|
| wheat: | 15 kg |
| calcium carbonate: | 55 kg |
| magnesium oxide: | 75 kg |
| mono-dicalcium phosphate: | 487 kg |
| calcium chloride | 233 kg |
| vitamins, medicaments, dyes | 45 kg |
| water | enough to obtain desired moisture content |

The granules obtained are essentially spherical, are of generally uniform size between 3 mm and 6 mm, they have a moisture content of 12.5%, they have a PDI of 98.9 and a coefficient of variability of 1.13 for phosphorous, 4.55 for calcium, 1.18 for magnesium and 2.20 for sodium on a dry basis. This feed was given to livestock and was well accepted by all unlike the counter part that is used in powder form.

### Example 2

A granular feed was prepared as in example except that it contained the following:

| | |
|---|---|
| wheat: | 383 kg |
| mono-ammonium phosphate | 173 kg |
| magnesium oxide | 80 kg |
| mono-dicalcium phosphate | 232 kg |
| vitamins, medicaments, dyes | 42 kg |
| water | enough to obtain desired moisture content |

The granules obtained are essentially spherical, are of generally uniform size between 3 mm and 6 mm, they have a moisture content of 11.5%, they have a PDI of 99.9 and a coefficient of variability of 1.08 for phosphorous, 5.12 for calcium, 0.37 for magnesium and 2.93 for sodium on a dry basis. This feed was given to livestock and was well accepted by all unlike the counter part that is used in powder form.

Although the invention has been described with respect to preferred embodiments, it is understood that modifications are possible provided that they fall within the scope of the appended claims.

What is claimed is:

1. Feed for animals in granular form, wherein said granules are essentially spherical and contain at least one substance selected from the group consisting of at least one food material, at least one inorganic food supplement, and mixtures thereof, said granules being of generally uniform size between about 3 mm and 25 mm, said granules having a moisture content between about 5 and 20%, a Pellet Durability Index (PDI) higher than about 90% and a coefficient of variability lower than 10 for each component.

2. Feed for animals according to claim 1, which additionally comprises a binder.

3. Feed for animals according to claim 2, wherein said binder consists of molasses.

4. Feed for animals according to claim 1, wherein said substance comprises a food material.

5. Feed for animals according to claim 1, wherein said substance comprises an inorganic food supplement.

6. Feed for animals according to claim 1, wherein said substance comprises a mixture of at least one food material and at least one inorganic food supplement.

7. Feed for animals according to claim 1, wherein said food material is based on cereals and by-products thereof.

8. Feed for animals according to claim 1, wherein said food material comprises wheat, corn, oat, rye, canola, barley, or mixtures thereof.

9. Feed for animals according to claim 1, wherein said moisture content is between about 8 and 10%.

10. Feed for animals according to claim 1, wherein said inorganic food supplement is based on at least one of the following: phosphorus, calcium, magnesium, sodium, chlorine, copper, iron, iodine, manganese, selenium and zinc.

11. Feed for animals according to claim 10, wherein said inorganic food supplement contains calcium carbonate, magnesium oxide, mono-dicalcium phosphate, sodium chloride and the food material comprises wheat.

12. Feed for animals according to claim 10, wherein said inorganic food supplement contains mono-ammonium phosphate, magnesium oxide and mono-dicalcium phosphate, and the food material comprises wheat.

13. Feed for animals according to claim 1, wherein said granules additionally comprises at least one of vitamins, medicaments, dyes or mixtures thereof.

14. Process for preparing a feed for animals in granular form as claimed in claim 1, which comprises providing a powdery composition comprising at least one substance selected from the group consisting of at least one animal food material, at least one inorganic animal food supplement, and mixtures thereof, moistening said composition with water, tumbling said water moistened composition until obtaining substantially spherical granules of generally uniform size between about 3 mm and 25 mm, the amount of water added to moisten said composition being such that said granules have a moisture content between about 5 and 20%, and screening said granules to reach a Pellet Durability Index higher than about 90% and a coefficient of variability lower than about 10.

15. Process according to claim 14, which comprises adding a binder to said composition.
